(19) United States
(12) Patent Application Publication
(10) Pub. No.: US 2015/0232650 A1
(43) Pub. Date: Aug. 20, 2015

(54) POLYMER COMPOSITION AND MOULDED ARTICLES THEREOF

(71) Applicant: Apollo Tyres Global R&D B.V., Enschede (NL)

(72) Inventors: Louis-Philippe Antoine Eugene Maria Reuvekamp, Enschede (NL); Gerard Nijman, Losser (NL)

(21) Appl. No.: 14/422,389

(22) PCT Filed: Nov. 22, 2013
(86) PCT No.: PCT/NL2013/050843

§ 371 Date: Feb. 20, 2015

(30) Foreign Application Priority Data
Nov. 23, 2012 (NL) 2009869

(51) Int. Cl. C08L 23/08; C08L 23/16

(52) U.S. Cl. CPC C08L 23/08; C08L 23/16; C08L 2205/025; C08L 2205/03

(57) ABSTRACT

The invention relates to a polymer composition comprising 60-99 parts by weight of a first copolymer of monomer units of ethylene and an alpha-olefin, wherein the ethylene monomer unit content ranges from 45 to 56 wt. %, 1-20 parts by weight of a second copolymer of monomer units of ethylene and an alpha-olefin, and 0-20 parts by weight of a natural rubber. The invention further relates to a method for the preparation of the polymer composition. The vulcanized polymer composition is advantageously used in articles that need to be flexed at low temperatures.

The invention relates to a polymer composition comprising a copolymer of monomer units of ethylene and an alpha-olefin, as well as fillers. The invention also relates to a vulcanized rubber that is formed by vulcanization of the composition and to moulded articles that consist wholly or partially of the vulcanized rubber.

A polymer composition comprising a copolymer with monomer units of ethylene and an alpha-olefin, also referred to as EPM, and a copolymer with monomer units of ethylene, an alpha-olefin, and a non-conjugated diene, also referred to as EPDM, are typically blended with fillers and additives, such as plasticizers, reinforcing fillers, pigments, and a vulcanizing system to form a polymer composition. Such compositions are commonly used for the production of moulded articles, during which production the polymer composition is converted by vulcanization of the EP(D)M into the final vulcanized EP(D)M rubber. Typical examples of moulded articles that consist wholly or partially of vulcanized EP(D)M rubber are seal profiles for windows in cars and buildings, roofing film and conveyor belts, tires, and the like.

EP(D)M is also particularly suitable for manufacturing flexible bodywork parts of cars or other vehicles, such as flexible air-guiding devices. A flexible air-guiding device is for instance described in U.S. Pat. No. 7,055,891 B2. The described air-guiding device comprises a spoiler lip and an operating element. The spoiler lip is attached to the bottom of the bumper and can be moved in and out by means of the operating element. A resilient connection between the spoiler lip and the bumper holds the air-guiding device in the moved-in inoperative position. The operating member may be in the form of an inflatable chamber, disposed on the rear side of the spoiler lip. When the inflatable chamber is inflated, the spoiler lip moves forward from the moved-in position to the moved-out position. When deflating the inflatable chamber, the spoiler lip moves backward from the moved-out position to the moved-in position. A plastic rod or the like, extending along the vehicle width and arranged at a free end of the spoiler lip may be present to provide lateral guiding.

The in and out movements of the spoiler lip of the air-guiding device cause flexing thereof around the connection with the bumper. Although vulcanized EP(D)M rubber possesses a good resistance to ozone, heat and oxidation and good mechanical properties, it has been established that the EP(D)M rubber causes problems when flexed around a relatively small radius a number of times in a cyclic fashion. It would be desirable to provide a better flexing behaviour, in particular at low temperatures. It has been suggested to blend different elastomeric polymers to obtain improved properties.

However, blending typically goes at the expense of some properties, and, in case of EP(D)M, its good weather resistance may be compromised.

The aim of the present invention therefore is to provide a polymer composition having the desirable combination of a good weather resistance and an improved flexing behaviour at low temperatures.

This and other aims are achieved by a polymer composition comprising 60-99 parts by weight of a first copolymer of monomer units of ethylene and an alpha-olefin, wherein the ethylene monomer unit content ranges from 45 to 56 wt. %, 1-20 parts by weight of a second copolymer of monomer units of ethylene and an alpha-olefin, and 0-20 parts by weight of a natural rubber. The relatively low ethylene monomer unit content in the first copolymer, preferably in combination with the presence of natural rubber in the given relative amounts, leads to a composition that not only exhibits an improved flexing behaviour at low temperatures but also provides a good weather resistance and mechanical properties. This is surprising since a relatively low ethylene content in a copolymer of monomer units of ethylene and an alpha-olefin is known to lower mechanical properties, in particular tensile strength. An even more preferred polymer composition comprises a first and/or second copolymer wherein the ethylene monomer unit content ranges from 48 to 54 wt. %.

Another advantage of the polymer composition according to the invention is that a vulcanized rubber with good resistance to cyclic loads is obtained with low hysteresis, in particular at low temperatures. The polymer composition according to the invention is advantageously used at low temperatures, by which are meant temperatures below 0° C., more preferably below −10° C., and most preferably below −20° C.

In an embodiment of the invention, the first and second copolymer differ from each other. Another embodiment in accordance with the invention provides a polymer composition, wherein the ethylene monomer unit content in the second copolymer is also relatively low, i.e. ranges from 45 to 56 wt. %. A preferred embodiment comprises a polymer composition, wherein the first and second copolymer are the same. Such a composition therefore comprises 80-100 parts by weight of a copolymer of monomer units of ethylene and an alpha-olefin, wherein the ethylene monomer unit content ranges from 45 to 56 wt. %, and 0-20 parts by weight of a natural rubber.

A preferred embodiment comprises 60-98 parts by weight of the first copolymer of monomer units of ethylene and an alpha-olefin, wherein the ethylene monomer unit content ranges from 45 to 56 wt. %, 1-20 parts by weight of the second copolymer of monomer units of ethylene and an alpha-olefin, and 1-20 parts by weight of a natural rubber.

In another embodiment of the invention, the polymer composition comprises 80-95 parts by weight of the first copolymer, 2.5-10 parts by weight of the second copolymer, and 2.5-10 parts by weight of a natural rubber, or, in an embodiment wherein the second copolymer is the same as the first copolymer, 90-97.5 parts by weight of a copolymer of monomer units of ethylene and an alpha-olefin, wherein the ethylene monomer unit content ranges from 45 to 56 wt. %, and 2.5-10 parts by weight of a natural rubber.

Although the desirable effect of a good weather resistance combined with an improved flexing behaviour is obtained with a polymer composition in accordance with claim 1, further desirable properties are obtained when providing an embodiment of the polymer composition that further comprises a non-conjugated diene.

Although the non-conjugated diene monomer unit content in the first and/or second copolymer typically varies between 0-15 wt. %, a polymer composition wherein the diene monomer unit content ranges from 1-12 wt % is preferred, whereas a range of 5-10 wt. % is particularly preferred.

The alpha-olefin applied in the copolymer of the invention may comprise an alpha-olefin with for instance 3-10 carbon atoms. Examples of suitable alpha-olefins are propylene, butylene, hexene, octene and the like. Preferably, the alpha-olefin monomer comprises propylene.

The non-conjugated diene monomer units may be chosen from those known in the art. Non-limitative examples of non-conjugated dienes that can be applied in embodiments of the copolymer are vinylidene norbornene, ethylidene norbornene, dicyclopentadiene and 1.4-hexadiene, or blends thereof, but dicyclopentadiene and in particular ethylidene norbornene are the preferred diene monomer units.

The copolymer used in the polymer composition according to the invention may be prepared by any means known in the art, such as by polymerisation with the aid of a Ziegler-Natta catalyst or a metallocene catalyst.

A particularly desirable polymer composition comprises 90-97.5 parts by weight of a copolymer of monomer units of ethylene, an alpha-olefin, and ethylidene norbornene, wherein the ethylene monomer unit content ranges from 48 to 54 wt. % and the ethylidene norbornene monomer unit content ranges from 3-10 wt. %, and 2.5-10 parts by weight of a natural rubber.

The polymer composition according to the invention may comprise fillers. Suitable fillers include carbon black, clay, silica, talc, chalk and pigments, additives, such as vulcanizing agents, accelerators, processing aids, such as fatty acid esters, alcohols and oils, and the like.

An embodiment of the polymer composition according to the invention comprises 40-100 parts by weight of filler for every 100 parts by weight of copolymer and natural rubber. In another embodiment of the polymer composition according to the invention, the filler comprises carbon black, whereby the polymer composition preferably comprises 40-100 parts by weight of carbon black, more preferably 50-90 parts by weight of carbon black, and most preferably 60-80 parts by weight of carbon black.

The polymer composition according to the invention can be prepared in any manner known in the art. Any known method of mixing polymers, fillers and other additives is in principle suitable for this purpose. It is thus possible to mix the copolymer, supplemented with additives and/or other elastomeric polymers if desired, using an internal mixer or Banbury mixer, a single or double-screw extruder apparatus, a blade kneader, a Buss Co-kneader, a two-roll mill, and the like. Suitable mixing temperatures are substantially determined by the rheological properties of the constituents of the polymer composition.

The invention also relates to a vulcanized rubber that is formed by vulcanization of the polymer composition according to the invention. Although not essential, it is possible for the polymer composition according to the invention to contain another elastomeric polymer besides the first and second copolymers and the natural rubber. Suitable examples of elastomeric polymers can be selected from known rubber polymers, preferably unsaturated rubber polymers. In general these rubbers have a glass transition temperature Tg lower than −10° C., although this is not essential. Rubbers suitable for application are for instance chosen from the group of natural rubbers, isoprene rubbers, butadiene rubbers, styrene butadiene copolymer rubbers, acrylonitrile butadiene copolymer rubbers, if desired copolymerized with styrene, butadiene isoprene copolymer rubbers, chloroprene rubbers, butyl and acryl rubbers, and ethylene-propylene copolymers which, if desired, comprise a third copolymerizable diene monomer such as for instance 1,4-hexadiene, dicyclopentadiene, dicyclooctadiene, methylene norbornene, ethylidene norbornene and tetrahydroindene. The rubber polymer applied in the method is preferably an ethylene-propylene rubber, and the applied rubber polymer is more preferably an ethylene-propylene-diene rubber (EPDM). Mixtures of said rubber polymers are likewise possible.

Any vulcanization system suitable for vulcanizing the polymer composition according to the invention may be used. Suitable vulcanizing systems are sulphur-based and peroxide-based systems, and combinations thereof.

Peroxides may be selected from a wide range of peroxides, suitable for cross linking the copolymer in the polymer composition. Preferred peroxides are selected from the group of peroxides that are relatively stable at storage temperature but also relatively stable at compounding temperature. Examples of preferred peroxides include 2,5-dimethyl-2,5-di(tert-butylperoxy)hexane (DTBPH), dicumyl peroxide (DCP), benzoyl peroxide (BP) and di(tert-butylperoxyisopropyl)benzene (DTBPIB).

The sulphur used in an optional sulphur-based vulcanizing system preferably comprises elemental sulphur. In addition accelerators may be used to facilitate the sulphur vulcanization reaction. The accelerators may be selected from the group consisting of thiophosphates, benzothiazoles, benzothiazolesulfenamides, thiurams, and dithiocarbamates. Examples of suitable accelerators are 2-mercaptobenzothiazoles (MBT), 2,2′-dithiobenzothiazole (MBTS), N-cyclohexylbenzothiazole-2-sulfenamide (CBS), N-t-butylbenzothiazole-2-sulfenamide (TBBS), 2-morpholinothiobenzothiazole (MBS), N-dicyclohecxylbenzothiazole-2-sulfenamide (DCBS), tetramethylthiuram monosulfide (TMTM), tetramethylthiuram disulfide (TMTD), zinc dimethyldithiocarbamate (ZDMC), zinc diethyldithiocarbamate (ZDEC) and combinations thereof, but others are also within the scope of the present invention.

A cross-linker for the copolymer may be added if desired. Particularly suitable cross-linkers, in particular for EPDM copolymers, comprise phenol resins in combination with a tin chloride compound as catalyst. In addition, it is also possible to apply cross-linkers on the basis of sulphur and/or peroxides. The copolymer may also be provided, if desired, with reactive groups such as for instance hydroxyl groups, alkoxysilyl groups, amino and epoxide groups and/or carboxyl groups. Particularly suitable copolymers are those provided with carboxyl groups, for instance by grafting unsaturated dicarboxylic anhydride compounds onto the copolymer. A maleic anhydride-functionalized copolymer is in particular suitable.

The invention also relates to a method for the preparation of the polymer composition. A preferred method comprises pre-mixing 30-70 parts by weight of the second copolymer and 70-30 parts by weight of the natural rubber, and mixing 5-30 parts by weight of the thus obtained pre-mixture with 70-95 parts by weight of the first copolymer. Pre-mixing the second copolymer and the natural rubber and then mixing the premix with the first copolymer and optional fillers yields better mechanical properties that when mixing all components in one operation. Pre-mixing 40-60 parts by weight of the second copolymer and 60-40 parts by weight of the natural rubber yields even better results, whereas premixing about equal amounts of the second copolymer and the natural rubber.(a 50/50 mixture) provides the best mechanical properties. The first and second copolymer may differ but may also be the same co-polymer.

The invention also relates to moulded articles that consist wholly or partially of the vulcanized rubber. Very good results are achieved with moulded articles that are subjected in their application to flexure around relatively small radii, in particular in combination with cyclic loads, and preferably at low temperatures. Cyclic loads are understood to be loads of a magnitude that varies in time, according to a regular pattern or not.

Excellent results are obtained if the moulded article comprises a flexible air-guiding device of a vehicle. Other moulded articles however are also possible, such as tire tread layers, conveyor belts, drive belts, door seal profiles, engine mounts, exhaust suspension rubbers an the like.

The invention will now be further illustrated with reference to the following example, without however being limited thereto.

### EXAMPLE

The EPDM material used in the example was a copolymer of ethylene, propylene and ethylidene norbornene, with an ethylene monomer unit content of 51 wt. %, and an ethylidene norbornene content of 9.5 wt. %. This EPDM was also used in preparing the premix. The EPDM premix was first prepared by mixing the components in the relative amounts given in Table 1.

TABLE 1
composition of premix

| Component | parts by weight |
|---|---|
| EPDM | 50 |
| Natural rubber | 50 |

The premix was then mixed with the other components in the relative amounts given in Table 2.

TABLE 2
composition of Example

| Component | Parts by weight |
|---|---|
| EPDM premix | 15 |
| EPDM | 85 |
| Carbon black | 70 |
| Oil | 20 |
| Zinc oxide | 5 |
| Stearic acid | 1 |
| Sulphur vulcanizing system | 10 |
| Peroxide vulcanizing system | 15 |

Mixing was carried out in an internal mixer for about 5 minutes. The fillers and processing aids were added after 1 minute mixing. The temperature of mixing was about 150° C. and cooling was performed at 50° C. The vulcanizing system was then added and mixed in at a maximum temperature of 100° C. The mixture upon released from the mixer was rolled out to a sheet using a two-roll mill and then pressed to form sheets with a thickness of about 2 mm and vulcanized at a temperature of 150° C. and a pressure of 100 bar. Test samples were punched out of the sheets to measure the mechanical properties.

Comparative Experiment

An EPDM material comprising a copolymer of ethylene, propylene and ethylidene norbornene, with an ethylene monomer unit content of 65 wt. %, and an ethylidene norbornene content of 9.5 wt. % was mixed with other components in the relative amounts given in Table 3. Mixing and preparing test samples was carried out as in the Example given above.

TABLE 3
Composition of Comparative Experiment

| Component | Parts by weight |
|---|---|
| EPDM | 100 |
| Carbon black | 70 |
| Oil | 20 |
| Zinc oxide | 5 |
| Stearic acid | 1 |
| Sulphur vulcanizing system | 10 |
| Peroxide vulcanizing system | 15 |

Results

The mechanical properties of the test samples show a lower level of hysteresis than the polymer composition of the Comparative Experiment, in particular at temperatures below 0° C. The tear resistance and tensile strength of the test samples in accordance with the invention are higher than those of the polymer composition of the Comparative Experiment, in particular at higher temperatures.

1. Polymer composition comprising 60-99 parts by weight of a first copolymer of monomer units of ethylene and an alpha-olefin, wherein the ethylene monomer unit content ranges from 45 to 56 wt. %, 1-20 parts by weight of a second copolymer of monomer units of ethylene and an alpha-olefin, and 0-20 parts by weight of a natural rubber.

2. Polymer composition according to claim 1, wherein the ethylene monomer unit content in the second copolymer ranges from 45 to 56 wt. %.

3. Polymer composition according to claim 1, wherein the first and second copolymer are the same.

4. Polymer composition according to claim 1, comprising 60-98 parts by weight of the first copolymer, 1-20 parts by weight of the second copolymer, and 1-20 parts by weight of a natural rubber.

5. Polymer composition according to claim 1, comprising 80-95 parts by weight of the first copolymer, 2.5-10 parts by weight of the second copolymer, and 2.5-10 parts by weight of a natural rubber.

6. Polymer composition according to claim 1, wherein the ethylene monomer unit content in the first and/or the second copolymer ranges from 48 to 54 wt. %.

7. Polymer composition according to claim 1, wherein the first and/or second copolymer further comprises a non-conjugated diene.

8. Polymer composition according to claim 7, wherein the first and/or second copolymer comprises 1-12 wt % of non-conjugated diene monomer units.

9. Polymer composition according to claim 7, wherein the non-conjugated diene comprises a norbornene, preferably ethylidene norbornene.

10. Polymer composition according to claim 1, wherein the alpha-olefin monomer comprises propylene.

11. Polymer composition according to claim 1, comprising 40-100 parts by weight of fillers.

12. Polymer composition according to claim 1, wherein the fillers comprise carbon black.

13. Moulded article comprising a vulcanized rubber, formed by vulcanization of the polymer composition according to claim 1.

14. Moulded article according to claim 13, wherein the article comprises a component that needs to be flexed at temperatures below −20° C.

15. Moulded article according to claim 13, the article comprising a flexible air-guiding device for a vehicle.

16. Method for the preparation of a polymer composition according to claim 1, the method comprising pre-mixing 30-70 parts by weight of the second copolymer and 70-30 parts by weight of the natural rubber, and mixing 5-30 parts by weight of the thus obtained pre-mixture with 70-95 parts by weight of the first copolymer.
